(19) United States
(12) Patent Application Publication
(10) Pub. No.: US 2026/0302849 A1
(43) Pub. Date: Oct. 1, 2026

(54) End-Face Stator Lamination for a Stator Body of a Stator of an Electric Machine

(71) Applicant: BAYERISCHE MOTOREN WERKE AKTIENGESELLSCHAFT, Muenchen (DE)

(72) Inventors: Thomas EIDENBOECK, Hofkirchen im Traunkreis (AT); Jochen KRONSTEINER, St. Ulrich bei Steyr (AT); Andreas WAGNER, St. Valentin (AT)

(21) Appl. No.: 18/880,343

(22) PCT Filed: Jul. 12, 2023
(86) PCT No.: PCT/EP2023/069259

§ 371 Date: Dec. 31, 2024

(30) Foreign Application Priority Data
Jul. 29, 2022 (DE) 10 2022 119 047.1

(51) Int. Cl. H02K 1/20; H02K 1/26

(52) U.S. Cl. CPC H02K 1/20; H02K 1/265

(57) ABSTRACT

Proposed is an end-face stator lamination for a stator body of a stator of an electric machine, the end-face stator lamination being configured to be arranged on a planar end face of the stator body. The end-face stator lamination has one or more nozzle depressions which are each configured to form, together with the planar end face of the stator body, one or more corresponding cavities for receiving coolant. The end-face stator lamination further includes at each of the one or more nozzle depressions, a hole that is configured to form a coolant jet of coolant from the relevant cavity.

### BACKGROUND AND SUMMARY

The invention relates to an electric machine, for example, a synchronous machine. In particular, the invention relates to the cooling of the winding head of a stator of an electric machine.

An at least partially electrically powered vehicle comprises an electric machine for powering the vehicle. The electric machine comprises a stator which surrounds a rotor of the electric machine. The electric machine moreover typically has a coolant circuit in order to cool the electric machine, in particular the electric windings of the stator. The coolant can be routed in hollow coolant ducts inside the stator body of the stator. The coolant can moreover be sprayed onto the winding head at an end face of the stator body with the aid of nozzles. It can, however, occur here that an insufficiently strong coolant jet is formed by the nozzles, which adversely affects the cooling efficiency of the winding head. Moreover, coolant can pass into the air gap between the stator and the rotor at the end face of the stator body, as a result of which the efficiency of the electric machine is adversely affected.

This document concerns the technical object of increasing the efficiency and accuracy of the cooling of a winding head at the end face of the stator body of a stator.

The object is achieved by the independent claim. Advantageous embodiments are described, inter alia, in the dependent claims. It should be pointed out that additional features of a claim which is dependent on an independent claim can form, without the features of the independent claim or only in combination with some of the features of the independent claim, a separate invention which is independent of the combination of all the features of the independent claim and can be made a subject of an independent claim, a divisional application, or a subsequent application. This equally applies to technical teachings which are described in the description and can form an invention which is independent of the features of the independent claims.

According to one aspect, an end-face stator lamination for a stator body of a stator of an electric machine is described. The end-face stator lamination is designed to be arranged at a flat end face of the stator body. The stator body can, for example, have a base body with a plurality of flat stator laminations. The base body can here extend from a first outer (flat) end face as far as an opposite second outer (flat) end face. The end-face stator lamination can be designed to be arranged (in particular fastened) at the first outer end face or at the second outer end face of the base body in order to form the stator body. The stator body can then have a lamination stack which has (or is composed of) the plurality of flat stator laminations of the base body and one or two end-face stator laminations.

An end-face stator lamination has one or more nozzle recesses which are each designed to form, together with the flat end face of the stator body, one or more corresponding cavities for holding coolant (in particular oil) (when the end-face stator lamination is arranged at the flat end face of the stator body). The one or more nozzle recesses can have been manufactured efficiently by a sheet-metal shaping process, in particular by a deep-drawing process, from a flat metal sheet, in particular from a flat stator lamination. In a preferred example, a stator lamination used for the base body can be shaped in order to form the end-face stator lamination with the one or more nozzle recesses. An end-face stator lamination can thus be manufactured particularly efficiently. The individual nozzle recesses can have the (round) shape of a dent and/or indentation.

The end-face stator lamination preferably has a plurality of nozzle recesses which are arranged, running circumferentially, in particular distributed uniformly, about the (centrally extending) longitudinal axis of the stator body. The stator body can have, for example, N stator grooves (for example, N=8 or more, or N=16 or more). The end-face stator lamination can possibly have a corresponding number of N nozzle recesses or fewer than N nozzle recesses. For example, the end-face stator lamination can have 4 or more, or 8 or more, nozzle recesses. Particularly reliable cooling of the winding head of the stator arranged at the end-face stator lamination can be produced by providing a uniformly distributed arrangement of a plurality of nozzle recesses.

The end-face stator lamination has, at each of the one or more nozzle recesses, in each case (at least or exactly) one hole which is designed to form a coolant jet with coolant from the respective cavity. The holes of the individual nozzle recesses can thus have the function of a nozzle opening in order to form in each case a coolant jet.

The holes of the individual nozzle recesses can in each case be oriented toward the centrally extending longitudinal axis of the stator body (i.e., toward the axis of rotation of the rotor). The position and/or the orientation of the holes can here possibly differ in different nozzle recesses of the plurality of nozzle recesses. The individual holes can thus be used to align the coolant jets produced in each case optimally with respect to the winding head to be cooled. Particularly efficient and reliable cooling of a winding head can thus be produced.

The stator can thus, at the flat end face of the stator body at which the end-face stator lamination is arranged, have a winding head which projects in an axial direction beyond the flat end face of the stator body. The holes of the one or more nozzle recesses can in each case be designed to produce a coolant jet directed onto the winding head (when the end-face stator lamination is arranged at the flat end face of the stator body). Particularly efficient and reliable cooling of the winding head can thus be produced.

A stator lamination, manufactured by shaping sheet metal, for arrangement at the end face of a stator body is thus described. This end-face stator lamination has one or more nozzle recesses with in each case one nozzle opening, wherein nozzles are efficiently formed by the one or more nozzle recesses in order to form reliable coolant jets for cooling a winding head of the stator.

The stator body can have at least one axial coolant duct (typically a plurality of axial cooling ducts) extending in an axial direction. The coolant duct can be arranged, for example, in the stator yoke and/or in a stator tooth of the stator body. The stator body can possibly have in each case at least or exactly one coolant duct for each and/or in each stator tooth.

The end-face stator lamination can have one or more duct recesses which are each designed to form, together with the flat end face of the stator body, one or more corresponding end-face coolant ducts between the axial coolant duct and at least one nozzle recess (when the end-face stator lamination is arranged at the flat end face of the stator body).

The end-face stator lamination can thus have additional one or more (duct-shaped) recesses in order to form one or more corresponding coolant ducts which run along the flat end face perpendicular to the longitudinal axis of the stator body. These end-face coolant ducts route coolant from the one or more axial coolant ducts into the individual nozzle recesses and thus ensure an efficient and reliable supply of coolant to the nozzles formed by the nozzle recesses.

The individual (duct-shaped) duct recesses can have been manufactured efficiently by a shaping process, in particular by a deep-drawing process. The whole of the end-face stator lamination can be formed by shaping, in particular by deep-drawing, a flat metal sheet, in particular a flat stator lamination. The end-face stator lamination can have been manufactured in particular by such shaping.

The end-face stator lamination can have a stator yoke region and a plurality of stator tooth regions. The stator yoke region can here form or be part of the stator yoke of the stator body and/or the plurality of stator tooth regions can be or form part of the corresponding plurality of stator teeth of the stator body (when the end-face stator lamination is arranged at the flat end face of the stator body). The end-face stator lamination can thus be part of the lamination stack of the stator body such that the nozzle function of the end-face stator lamination can be provided particularly efficiently (without adversely affecting the power density of the electric machine).

The one or more nozzle recesses of the end-face stator lamination are preferably arranged in the stator yoke region. Particularly precise orientation of the individual coolant jets (outward) onto the winding head can thus be produced.

According to a further aspect, a stator body for a stator of an electric machine is described. The stator body comprises a base body with a plurality of flat (identically formed) stator laminations. The base body extends from a first outer end face as far as an opposite second outer end face. The stator can have in each case one winding head at the two outer end faces.

The stator body moreover comprises a first end-face stator lamination which is formed as described in this document and which is arranged at the first outer end face of the base body. The stator body can furthermore have a second end-face stator lamination which is formed as described in this document and which is arranged at the second outer end face of the base body. As already explained above, particularly efficient and reliable cooling of the winding heads of the stator can be produced by the one or two end-face stator laminations.

The stator body, in particular the base body, can have at least one axial coolant duct which runs in an axial direction through the base body. The first and/or second end-face stator lamination can in each case be designed to route coolant from the at least one axial coolant duct to the one or more nozzle recesses of the respective end-face stator lamination. Particularly reliable cooling of the whole stator, in particular all of the stator windings, can thus be produced.

The base body can comprise a first part-body and a second part-body with in each case one or more axial coolant ducts which are arranged one behind the other in an axial direction. The two part-bodies can each have part (for example, half) of the stator laminations of the base body.

The base body can comprise a stator component, arranged between the first part-body and the second part-body, which is designed to route coolant from outside the stator body into the one or more axial coolant ducts of the first and second part-body. The stator component can here itself be designed as a stator lamination. Central supply of coolant to the stator body can thus be produced in order to enable particularly reliable and efficient cooling.

According to a further aspect, a stator for an electric machine is described. The stator comprises a stator body which is designed as described in this document. The stator moreover comprises a first winding head arranged at the first end-face stator lamination and/or a second winding head arranged at the second end-face stator lamination. The first and/or second end-face stator lamination are here in each case designed to produce coolant jets with coolant onto the respective winding head in order to produce efficient, reliable, and targeted cooling of the respective winding head.

According to a further aspect, an electric machine, in particular a synchronous machine, with a rotor and a stator is described, wherein the stator is designed as described in this document.

The electric machine can be designed to route coolant, starting from an outer shell surface of the stator body of the stator, into one or more axial coolant ducts of the stator body of the stator, in particular at a location, arranged centrally in an axial direction, between two part-bodies of the stator body. The electric machine can moreover be configured to collect coolant, from the one or more axial coolant ducts and which has been used to cool a winding head of the stator, at least one end face of the stator body of the stator. This coolant can then be fed back to the one or more axial coolant ducts.

A coolant circuit for efficient and reliable cooling of the stator windings and/or the winding heads of the stator can thus be provided.

According to a further aspect, a (road) motor vehicle (in particular a car or a truck or a bus or a motorcycle) is described which comprises the electric machine described in this document.

It should be noted that the methods, devices, and systems described in this document can be used both alone and in combination with other methods, devices, and systems described in this document. Furthermore, any aspects of the methods, devices, and systems described in this document can be combined with one another in various ways. In particular, the features of the claims can be combined with one another in various ways. Moreover, features presented in brackets are to be understood as optional features.

The invention is described in detail hereinafter on the basis of exemplary embodiments, in which:

### BRIEF DESCRIPTION OF THE DRAWINGS

FIG. 1a shows an exemplary electric machine;

FIG. 1b shows an exemplary winding head at an end face of a stator;

FIG. 2a shows an exemplary cross section through a stator;

FIG. 2b shows an exemplary stator slot;

FIG. 3a shows an isometric view of an exemplary multi-part stator body with end-face stator laminations;

FIG. 3b shows an isometric view of an exemplary end-face stator lamination; and

FIG. 3c shows an isometric view of an exemplary end-face stator lamination and a winding head.

### DETAILED DESCRIPTION OF THE DRAWINGS

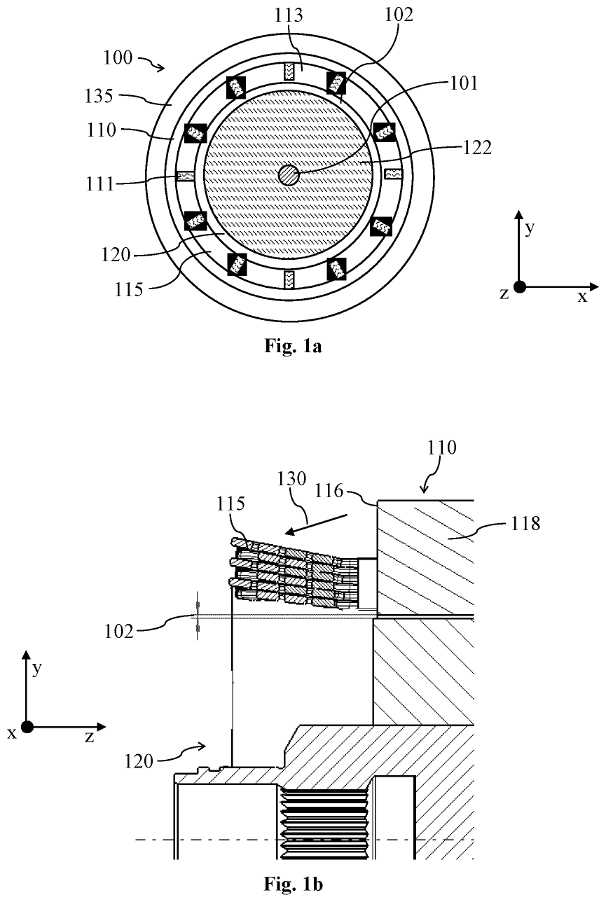

As stated at the beginning, the present document is concerned with increasing the efficiency and accuracy of the cooling of a winding head of a stator of an electric machine. In this connection, FIG. 1a shows an exemplary electric machine 100 in a view perpendicular to the shaft 101 of the electric machine 100. The shaft 101 of the electric machine 100 can correspond to the longitudinal axis of the stator 110 and/or the axis of rotation of the rotor 120 of the electric machine 100. The shaft 101 runs along the z-axis of the Cartesian coordinate system illustrated.

The electric machine 100 comprises a stator 110 with a plurality of stator windings 111 which are arranged at different angular positions around the axis of rotation of the rotor 120 and are configured to generate an electromagnetic rotating field. The stator 110 is surrounded by a housing 135 of the electric machine 100. The individual stator windings 111 can each be arranged in each case in a stator slot between two directly adjacent stator teeth 113 of the stator 110. An air gap 102 is arranged between the stator 110 and the rotor 120.

The electric machine 100 furthermore comprises the rotor 120 which is driven by the rotating field produced by the stator 110. The rotor 120 is connected fixedly to the shaft 101 driven by the electric machine 100 (which shaft is connected to the rotor axis of the rotor 120 or corresponds to the rotor axis of the rotor 120). The rotor 120 comprises a rotor body 122.

The rotor 120 of an electric machine 100 can have as a rotor body 122 an iron lamination stack (for example, composed of mutually insulated laminations). In a corresponding fashion, the stator body of the stator 110 can also be composed of individual (mutually insulated) stator laminations (for example, iron laminations).

The stator 110 extends along the axis of rotation or the longitudinal axis of the rotor 120 from a first end face as far as an opposite second end face. The stator 110 here has various magnetic stator teeth 113 which are arranged at different angular positions (uniformly distributed) about the axis of rotation of the rotor 120. A coil (i.e., in each case one or more tums or windings 111) by means of which a magnetic field is generated can in each case be arranged around the individual stator teeth 113. The individual stator teeth 113 can thus form magnetic poles of the stator 110. The tums or windings 111 form in each case a winding head at the end faces of the stator 110.

Formed between two directly adjacent stator teeth 113 of the stator 110 is in each case one stator slot in which the turns 111 are arranged. A stator slot extends along the longitudinal axis (i.e., along the z-axis) from the first end face as far as the opposite second end face of the stator 110. The turns 111 arranged in a stator slot can be electrically insulated from the (electrically conductive) stator body with the aid of a slot insulation.

FIG 1b illustrates the winding head 115, formed by the stator windings 111, at an end face 116 of the stator 110. The winding head 115 is typically cooled with a (liquid) coolant 130. The coolant 130 can be sprayed onto the winding head 115, for example, with one or more nozzles (not illustrated). In the case of the stator 110 described in this document, the coolant 130 for cooling the winding head 115 can be sourced efficiently from coolant duets of the stator body of the stator 110.

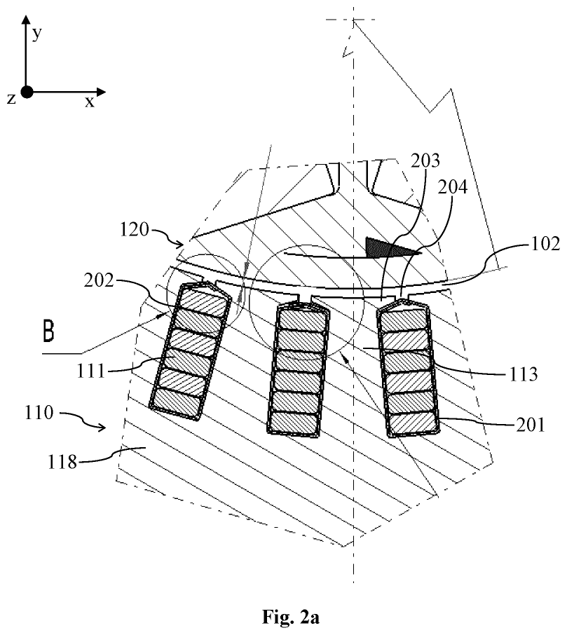

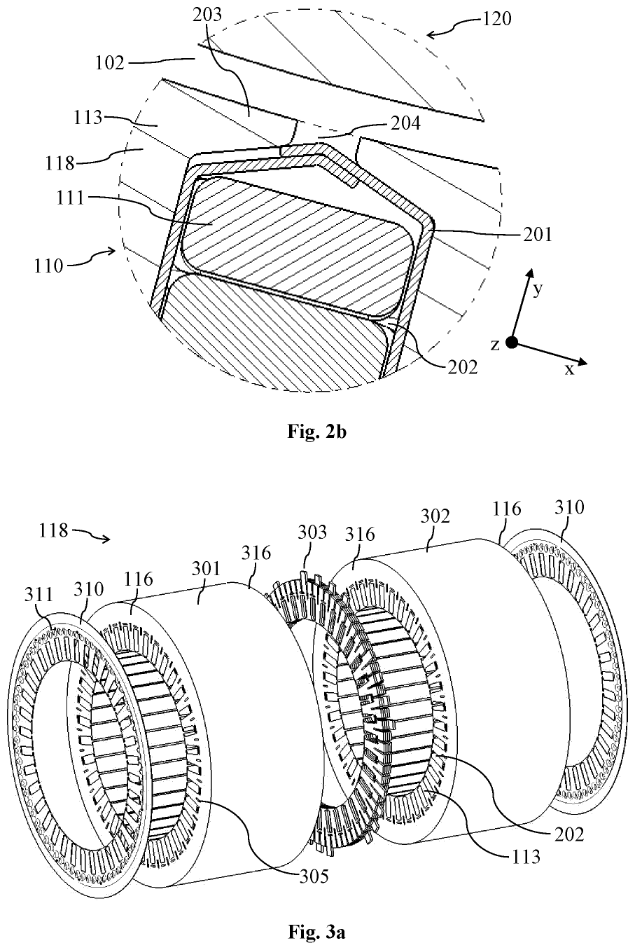

FIG. 2a shows a detail of the air gap 102 and the rotor 120 and stator 110 adjoining it. In particular, FIG. 2a shows three stator slots 202 which are each arranged between two directly adjacent stator teeth 113 of the stator body 118. Stator windings 111, which are each surrounded by a (prismatic) slot insulation 201 are arranged in each case in the stator slots 202. As already stated, the individual stator slots 202, the individual stator windings 111, and the individual slot insulations 201 each extend from a first end face 116 as far as the opposite second end face 116 of the stator 110 along the longitudinal axis, i.e., along the z-axis.

The individual stator teeth 113 can have, at the end facing the air gap 102, in each case a stator shoe 203 which extends along the air gap 102 in a tangential direction. A. wall of the stator slot 202 situated in between is formed by the stator shoes 203 of two directly adjacent stator teeth 113 (wherein the wall runs between the stator slot 202 and the air gap 102). The stator shoes 203 of the two directly adjacent stator teeth 113 typically do not touch each other, however, such that the stator slot 202 has a gap 204 facing the air gap 102, which gap 204 extends along the longitudinal axis from the first end face 116 as far as the opposite second end face 116 of the stator 110. FIG. 2a shows a stator slot 202, marked “B”, wherein the stator slot 202 is illustrated in FIG. 2b in an enlarged form.

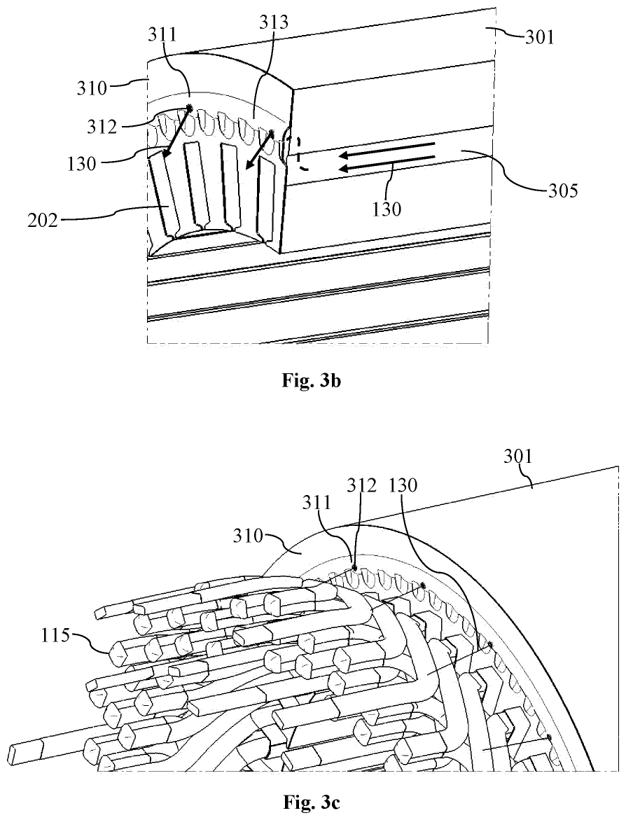

FIG. 3a shows an exemplary multi-part stator body 118 of a stator 110. The stator body 118 comprises a first part-body 301 and a second part-body 302 which are arranged one behind the other along the longitudinal axis of the stator body 118. The part-bodies 301, 302 can in each case be composed of a plurality of (identically formed) stator laminations, for example, in each case from 50 or more, or 100 or more stator laminations. The two part-bodies 301, 302 can moreover have the same structure such that in each case one half of the base body 301, 302 of the stator body 118 is formed by the two part-bodies 301, 302.

The stator body 118 can have, in the stator yoke and/or in the individual stator teeth 113, in each case one or more hollow coolant ducts 305 which run in each case in an axial direction, i.e., in the longitudinal direction. Coolant 130 can be routed in each case through the individual axial coolant ducts 305 in order to cool the stator windings 111.

A central stator component 303, in particular a central stator lamination, which bears against the central end faces 316 of the two part-bodies 301, 302 can be arranged between the two part-bodies 301, 302. The central stator component 303 can have a stator yoke and stator teeth 113. The central stator component 303 can moreover be designed to route coolant 130 from outside the stator body 118 into the axial coolant ducts 305 of the two part-bodies 301, 302.

As already stated, the present document concerns the efficient and targeted cooling of the winding heads 115 at the outer end faces 116 of the stator body 118. The stator body 118 illustrated in FIG. 3a has for this purpose in each case one end-face stator lamination 310 at the outer end faces 116. In particular, a first end-face stator lamination 310 is arranged at the outer end face 116 of the first part-body 301, and a second end-face stator lamination 310 is arranged at the outer end face 116 of the second part-body 302.

An end-face stator lamination 310 can have in each case a plurality of nozzle recesses 311 which are arranged, running circumferentially, at the yoke of the end-face stator lamination 310. A nozzle recess 311 can here in each case be designed as a local, possibly indentation- or dent-shaped recess of the stator lamination 310. The individual nozzle recesses 311 can be, for example, shaped from a flat piece of sheet metal as part of a deep-drawing process.

FIGS. 3b and 3c show further details of an end-face stator lamination 310. In particular, FIG. 3b illustrates that the individual nozzle recesses 311 in each case have a hole 312, for example, a bore, through which coolant 130 can exit in each case. In particular, a coolant jet onto the winding head 115 of the stator 110 can be produced by the hole 312 of a nozzle recess 311 (as illustrated in FIG. 3c).

FIG. 3b moreover shows how the coolant 130 is routed from an axial coolant duct 305 via one or more duct recesses 313 of the end-face stator lamination 310 to one or more nozzle recesses 311. The individual duct recesses 313 can be formed by duct-shaped recesses inside the end-face stator lamination 310.

As a whole, an end-face stator lamination 310 can be manufactured efficiently by deformation, in particular by deep-drawing, of a flat metal sheet. The individual nozzle recesses 311 and/or the individual duct recesses 313 which run between the axial coolant ducts 305 and the nozzle recesses 311 can be formed here by the deformation process.

In each case one end-face stator lamination 310 can be fastened (for example, adhesively bonded) at the outer end faces 116 of the stator body 118. The two end-face stator laminations 310 can be designed with the same structure and/or mirror-symmetrically (with a mirror plane which is oriented perpendicular to the longitudinal axis of the stator body 118).

Coolant nozzles (i.e., nozzle recesses 311 with in each case one hole 312) to which coolant 130 is reliably supplied from the axial coolant ducts 305 of the stator body 118 can be formed efficiently by the individual end-face stator laminations 310 such that coolant jets onto the winding head 115 arranged at the end-face stator lamination 310 can be reliably produced.

The nozzles designed as recesses 311 in an end-face stator lamination 310 form, together with the adjoining (flat) end face 116 of the part-body 301, 302 of the stator body 118, cavities in which coolant 130 can collect such that sufficient coolant 130 for forming the coolant jets can be provided. Duct-shaped recesses 313 in the end-face stator lamination 310 moreover form, together with the adjoining (flat) end face 116 of the part-body 301, 302 of the stator body 118, end-face coolant ducts via which coolant 130 can be efficiently and reliably routed from the axial coolant duets 305 to the individual nozzle recesses 311 and collected there.

The formation of relatively strong coolant jets enables reliable cooling of the winding heads 115 at the outer end faces 116 of the stator body 118. It can moreover thus be reliably avoided that coolant 130 passes into the air gap 102 between the rotor 120 and the stator 110 and the efficiency of the electric machine 100 is adversely affected as a result.

One or more deep-drawn laminations 310 can thus be integrated directly into the stacking process for producing the stator body 118 of the stator 110. The deep-drawn laminations 310 are integrated captively at both sides, i.e., end faces, of the stator body 118. With the aid of these laminations 310, all of the coolant 130 (in particular oil) exiting at the stator body 118 is focused and sprayed into the individual laminations 310 via holes 312 arranged in a defined fashion in order to optimally wet the stator windings 113, 115. The individual holes 312 can be defined and/or vary with reference to the respective angle and/or the respective position. Additional components are not required to produce the coolant jets, as a result of which efficient assembly is enabled.

The present invention is not limited to the exemplary embodiments shown. It should in particular be noted that the description and the Figures are intended to illustrate the principle of the proposed methods, devices, and systems only by way of example.

1-12. (Canceled)

13. An end-face stator lamination for a stator body of a stator of an electric machine, wherein
the end-face stator lamination is configured to be arranged at a flat end face of the stator body;
the end-face stator lamination has one or more nozzle recesses which are each configured to form, together with the flat end face of the stator body, one or more corresponding cavities for holding coolant when the end-face stator lamination is arranged at the flat end face of the stator body; and
the end-face stator lamination has, at each of the one or more nozzle recesses, at least one hole which is configured to form a coolant jet with coolant from a respective cavity.

14. The end-face stator lamination according to claim 13, wherein the end-face stator lamination has a plurality of nozzle recesses which are arranged, running circumferentially and distributed uniformly, about a longitudinal axis of the stator body; and
the end-face stator lamination includes 4 or more nozzle recesses.

15. The end-face stator lamination according to claim 14, wherein the end-face stator lamination includes 8 or more nozzle recesses.

16. The end-face stator lamination according to claim 14, wherein
a position and/or an orientation of the at least one hole differs in two different nozzle recesses of the plurality of nozzle recesses; and/or
the at least one hole of a first nozzle recess of the plurality of nozzle recesses is oriented toward a centrally extending longitudinal axis of the stator body.

17. The end-face stator according to claim 13, wherein
the stator body has at least one axial coolant duct extending in an axial direction; and
the end-face stator lamination has one or more duct recesses which are each configured to form, together with the flat end face of the stator body, one or more corresponding end-face coolant ducts between the at least one axial coolant duct and the one or more nozzle recesses when the end-face stator lamination is arranged at the flat end face of the stator body.

18. The end-face stator lamination according to claim 13, wherein
the end-face stator lamination has a stator yoke region and a plurality of stator tooth regions;
the stator yoke region forms part of a stator yoke of the stator body and the plurality of stator tooth regions for part of a corresponding plurality of stator teeth of the stator body when the end-face stator lamination is arranged at the flat end face of the stator body; and
the one or more nozzle recesses are arranged in the stator yoke region.

19. The end-face stator lamination according to claim 13, wherein
the stator has, at the flat end face of the stator body at which the end-face stator lamination is arranged, a winding head which projects in an axial direction beyond the flat end face of the stator body; and
the holes of the one or more nozzle recesses are each configured to produce a coolant jet directed onto the winding head when the end-face stator lamination is arranged at the flat end face of the stator body.

20. The end-face stator lamination according to claim 13, wherein the end-face stator lamination is configured to be manufactured by deep-drawing a flat metal sheet including a flat stator lamination.

21. A stator body for a stator of an electric machine, the stator body comprising:
a base body with a plurality of flat stator laminations, wherein the base body extends from a first outer end face as far as an opposite second outer end face; and
a first end-face stator lamination which is configured according to claim 13 and which is arranged at the first outer end face of the base body; and/or
a second end-face stator lamination which is configured according to claim 13 and which is arranged at the second outer end face of the base body.

22. The stator body according to claim 21, wherein
the base body has at least one axial coolant duct which runs in an axial direction through the base body; and
the first and/or second end-face stator lamination is in each case configured to route coolant from the at least one axial coolant duct to the one or more nozzle recesses of the respective end-face stator lamination.

23. The stator body according to claim 21, wherein the base body includes:
a first part-body and a second part-body, each of which includes one or more axial coolant ducts which are arranged one behind another in an axial direction; and
a stator component, arranged between the first part-body and the second part-body, which is configured to route coolant from outside the stator body into the one or more axial coolant duets of the first and second part-body.

24. A stator for an electric machine, the stator comprising:
a stator body which is configured according to claim 21; and
a first winding head arranged at the first end-face stator lamination and/or a second winding head arranged at the second end-face stator lamination;
wherein at least one of the first end-face stator lamination and the second end-face stator lamination are configured to produce coolant jets with coolant onto the respective winding head.

25. An electric machine including a rotor and a stator, which is configured according to claim 24, wherein the electric machine is configured to:
route coolant, starting from an outer shell surface of the stator body of the stator, into one or more axial coolant ducts of the stator body of the stator, at a location arranged centrally in an axial direction, between two part-bodies of the stator body; and
collect coolant, from the one or more axial coolant ducts, which has been used to cool a winding head of the stator, at least one end face of the stator body of the stator.
